(19) United States
(12) Patent Application Publication
(10) Pub. No.: US 2016/0224207 A1
(43) Pub. Date: Aug. 4, 2016

(54) METHOD AND SYSTEM FOR FREEZING AND UNFREEZING APPLICATIONS

(71) Applicant: Alibaba Group Holding Limited, George Town (KY)

(72) Inventors: Hongxing Wu, Beijing (CN); Tao Yao, Hangzhou (CN); Gong Zhang, Beijing (CN)

(21) Appl. No.: 15/006,582

(22) Filed: Jan. 26, 2016

(30) Foreign Application Priority Data
Jan. 29, 2015 (CN) 201510048086.X

(51) Int. Cl. G06F 3/0481; G06F 3/0484; G06F 3/0482

(52) U.S. Cl. CPC G06F 3/04817; G06F 3/0482; G06F 3/04842

(57) ABSTRACT

Freezing applications is disclosed including receiving a request for an application installed on a computer system, and in response to the request, setting a status of the application to a status value indicating that the application is to become unavailable while maintaining the application and its associated data on the computer system where the application cannot be invoked or run by an operating system after the status is set to the status value.

### CROSS REFERENCE TO OTHER APPLICATIONS

This application claims priority to People's Republic of China Patent Application No. 201510048086.X entitled A METHOD AND A DEVICE FOR FREEZING AND DEFROSTING APPS, filed Jan. 29, 2015 which is incorporated herein by reference for all purposes.

### FIELD OF THE INVENTION

The present application relates to a method and system for freezing and unfreezing applications.

### BACKGROUND OF THE INVENTION

As Internet technology develops, users are able to install various applications (apps) on terminals (e.g., personal computers, cell phones, and tablets) to obtain various services.

Currently, many applications, after being installed by users on terminals, run in the background as soon as a terminal's operating system is activated. However, many of these installed applications that automatically run in the background are not needed by users, yet these background-running applications occupy memory and generate unnecessary network traffic. Therefore, avoiding the automatic background running of applications not needed by users would be beneficial.

Conventionally, some applications are capable of being disabled via a disable option. The user disables the unnecessary applications and avoids wasting memory and generating unnecessary network traffic. However, not all applications provide a disable option. For applications that do not provide a disable option, if the user wants to prevent them from automatically running in the background, the user must uninstall the applications from the terminal. Yet, if the user wishes to subsequently use the applications, the user must reinstall the applications.

The conventional technique for managing applications and preventing them from running automatically in the background is extremely cumbersome and inconvenient.

### BRIEF DESCRIPTION OF THE DRAWINGS

Various embodiments of the invention are disclosed in the following detailed description and the accompanying drawings.

FIG. 1 is a flowchart illustrating an embodiment of a process for freezing applications.

FIG. 2 is a diagram illustrating an example of a preset hiding area.

FIG. 3 is a flowchart illustrating an embodiment of a process for unfreezing applications.

FIG. 4 is a diagram illustrating an embodiment of a system for freezing applications.

FIG. 5 is a diagram illustrating an embodiment of a system for unfreezing applications.

FIG. 6 is a functional diagram illustrating an embodiment of a programmed computer system for freezing and unfreezing applications.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

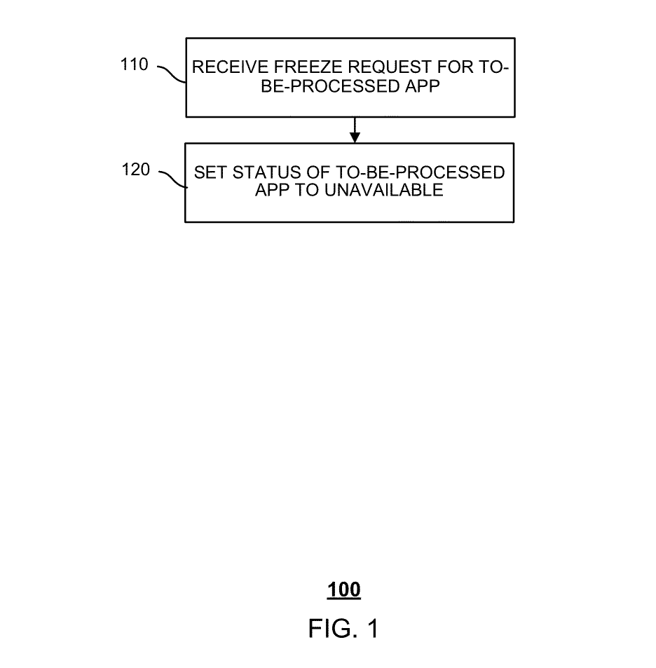

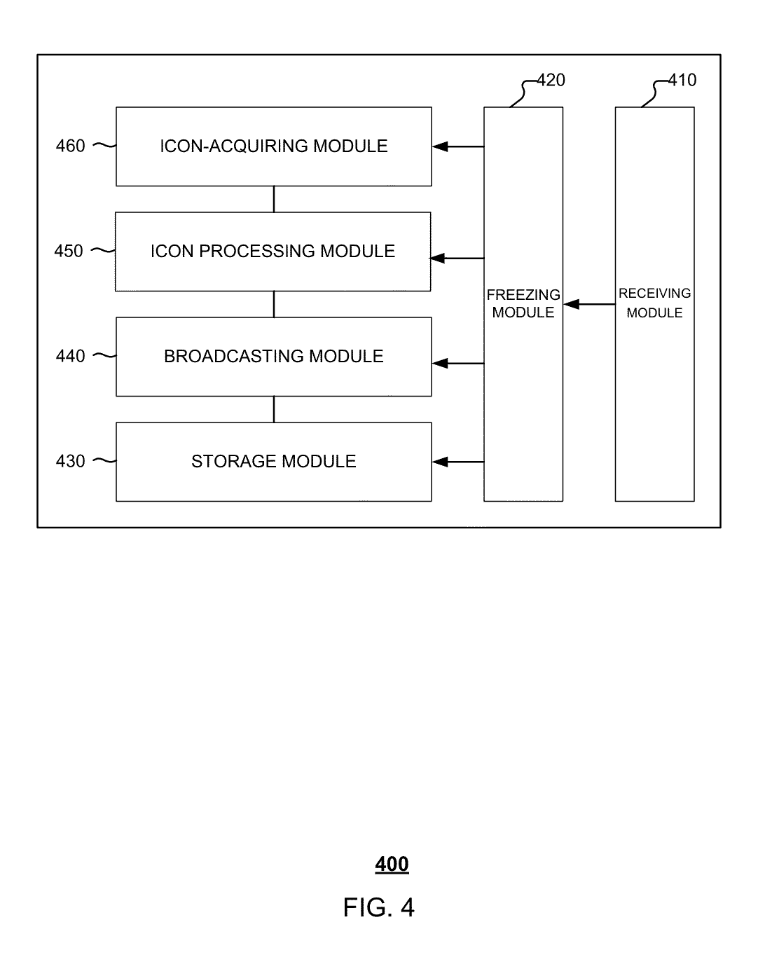

FIG. 1 is a flowchart illustrating an embodiment of a process for freezing applications. As used herein, the freezing of an application deactivates the application and prevents the application from being executable, but does not delete the application itself or its associated data from the terminal. In some embodiments, the process 100 is implemented by a system or terminal 400 of FIG. 4 and comprises:

In 110, the terminal receives a freeze request for a to-be-processed application (app).

In some embodiments, the user can issue a freeze request for an unnecessary app (also referred to as a “to-be-processed app”) via a user interface provided by an application. The operating system of the terminal can then receive the freeze request for the to-be-processed app.

For example, the user inputs the freeze request for the to-be-processed app via a designated system application in the operating system. The designated system application can be a system application having the highest authority, such as a system settings application or the like. As an example, a list of all applications installed on the terminal can be provided in advance to the system settings application by the operating system, and a freeze button corresponding to each app can be provided in the list by the system settings application. In some embodiments, when the user wishes to freeze a certain to-be-processed app, the user can click the freeze button corresponding to the to-be-processed app in the list provided to the system settings application. When the system settings application detects that the user has clicked a freeze button corresponding to a to-be-processed app, the system settings application informs the operating system that a freeze request input by the user and for the to-be-processed app has been received.

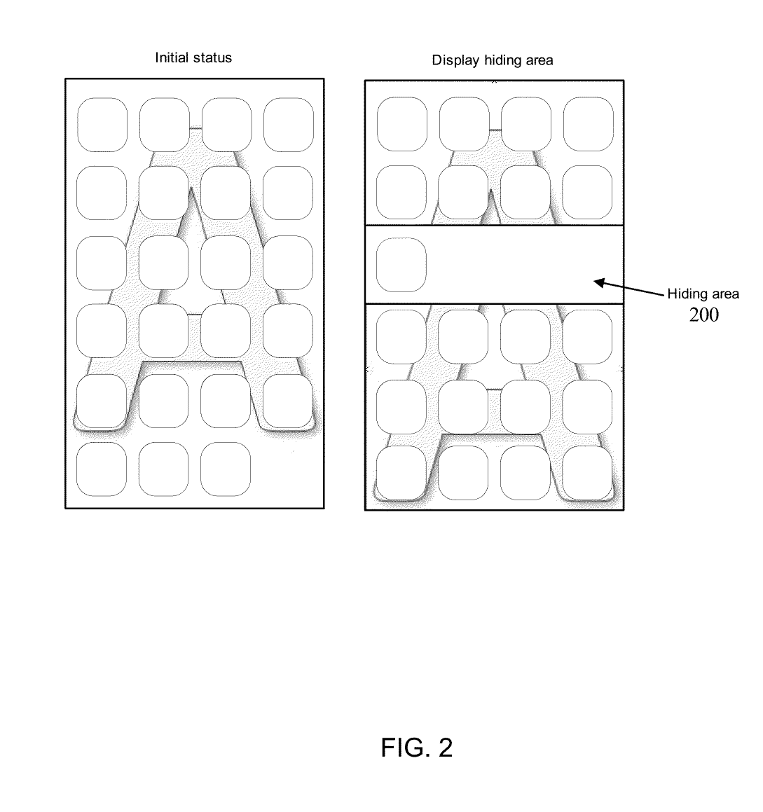

In some embodiments, a hiding area is preset in a user interface (UI). The hiding area can be used to store icons of applications that are to be frozen. In some embodiments, the hiding area is not displayed initially. In some embodiments, the hiding area is displayed only when a designated operation executed by the user is detected by terminal monitoring. In other words, the icons stored in the hiding area are displayed, as shown in FIG. 2.

FIG. 2 is a diagram illustrating an example of a preset hiding area. In FIG. 2, the hiding area 200 is preset on a desktop UI by the terminal's operating system. In an initial state, the hiding area is not displayed. When, for example, an input operation performed by the user such as spreading two fingers on a touchscreen displaying the desktop is detected, the operating system displays the hiding area and the icons stored in the hiding area. When an input operation performed by the user such as pinching two fingers together on the touchscreen displaying the desktop is detected, the system restores the hiding area to its initial state. In other words, the hiding area is not displayed.

Thus, in some embodiments, when a user wants to freeze a to-be-processed app, the user has the option of directly placing the icon for the to-be-processed app in the preset hiding area. For example, the user first performs the designated operation to cause the terminal to display the hiding area, and then drags the icon corresponding to the to-be-processed app from the desktop to the hiding area. When monitoring performed by the terminal's operating system detects that the user has placed the icon for the to-be-processed app in the preset hiding area, the operating system determines that a freeze request for the to-be-processed app has been received.

Referring back to FIG. 1, in 120, the terminal sets a status of the to-be-processed app to “application unavailable,” which can be set to a string, a value, or any other appropriate expression.

In some embodiments, after the terminal's operating system receives the freeze request for the to-be-processed app, the terminal's operating system can set the status for the to-be-processed app to “application unavailable” (or another status indicating that the application is unavailable) in a list of application statuses maintained by the operating system. In some embodiments, when the status of an application is set to “application unavailable,” all of the application's interfaces and functional modules are to be disabled. Therefore, applications having their status set to “application unavailable” are not and cannot be invoked or run by the system. In this case, an application type of the to-be-processed app having their status set to “application unavailable” corresponds to an uninstalled status.

The process 100 differs from merely uninstalling the application in that the application itself, the application data, and the user data corresponding to the to-be-processed app are not deleted by the operating system, but instead the application data and user data corresponding to the to-be-processed app are stored locally so that the user will not need to reinstall the to-be-processed app when the user later unfreezes the to-be-processed app. In other words, the application itself is not deleted, there are only limits on the application being invoked or executed. The user data differs from the application data in that the application data is included in the application installation package.

By using the above process 100, the user can input a freeze request for an unnecessary app. As a result, the terminal's operating system can set the status of the app to “application unavailable.” Because an app with a status set to “application unavailable” cannot be called, executed, or run, the app is to not automatically run in the background, the app is prevented from utilizing the terminal's memory resources and generating network traffic. Moreover, the user does not need to uninstall the app, and this process effectively makes app user management more convenient.

As an example, to ensure the security of the app-freezing process 100, when the operating system performs 120 of process 100 to set the status of the to-be-processed app to “application unavailable” based on the received application freeze request, the operating system can invoke a designated system application (the designated system application can be a system application having the highest authority such as a system settings application) and set the status of the to-be-processed app to “application unavailable” via the invoked designated system application. For example, a broadcast receiver can be set up in advance in the system settings application having the highest authority. The broadcast receiver can be implemented as software code that transmits and receives messages on a specific communication channel. The broadcast receiver can listen for a broadcast event, and the system can send an “application unavailable” event via a system interface, and the broadcast receiver can receive the “application unavailable” event. When the user drags the icon for the to-be-processed app into the hiding area to input a freeze request, the code implementing the hiding area and event detection associated with the hiding area will issue, via the broadcast receiver, a freeze-broadcast notice to the system settings application. A hiding area process corresponds to the desktop application program, and the desktop application program can invoke a system interface to send broadcast events. The system interface can issue the freeze-broadcast notice. By receiving the freeze-broadcast notice via the broadcast receiver, the system settings application can learn that the hiding area has received a freeze request for the to-be-processed app and then set the status of this to-be-processed app to “application unavailable.” Since the broadcast receiver of the system settings application is set up so that the broadcast receiver can only receive broadcast notices sent by desktop processes and hiding-area processes which are identified by their process names, the package name, or signature, the processes of other applications cannot pass themselves off as desktop processes or hiding-area processes and send freeze-broadcast notices. The desktop process is a system application, the desktop process provides a hiding area process, and correspondingly, the hiding area process belongs to the desktop process. This restriction prevents malicious freezing by the other applications and ensures the security of the app-freezing process 100.

Furthermore, in some embodiments, some applications on the terminal are more important than other applications (for example, system settings applications and other such system applications). If the more important applications are frozen, the result may be that the operating system becomes unstable or even crashes. Therefore, in operation 120, the terminal can further verify the to-be-processed app to ensure that the to-be-processed app is not one of the predesignated important applications. In some embodiments, the verification operation includes determining that the to-be-processed app exists and that the to-be-processed app is not an application required by the operating system. Upon verifying that the to-be-processed app is valid (in other words, it is not a pre-specified application such as an application required by the operating system), the status of the to-be-processed app is set to “application unavailable.”

In some embodiments, the freeze request in operation 110 includes an identifier for the to-be-processed app (e.g., the name of the to-be-processed app). Thus, in operation 120, the operating system can verify the to-be-processed app based on the to-be-processed app identifier included in the freeze request. Moreover, upon verification, the terminal can set the status of the to-be-processed app to “application unavailable” in the list maintained by the operating system.

As an example, the operating system searches for the to-be-processed app based on the to-be-processed app identifier included in the freeze request. In another example, the operating system searches for program code of the to-be-processed app. The program code can refer to program attributes of a system application or a third party application. In this example, when the operating system determines that the to-be-processed app exists and that the to-be-processed app is not a system application, the operating system determines that the to-be-processed app can be frozen. In some embodiments, the operating system can also store and maintain an identifier list for all currently-installed applications, and mark identifiers corresponding to system applications in the identifier list. Thus, when the to-be-processed app is undergoing verification based on the to-be-processed app identifier included in the freeze request, the identifier list can be searched to determine whether the identifier list includes the identifier for the to-be-processed app. If the identifier list includes the identifier for the to-be-processed app, the operating system determines whether the to-be-processed app is marked as a system application by checking the to-be-processed app identifier in the list of identifiers. If the to-be-processed app is not marked as a system application, then the to-be-processed app passes verification. In other words, only a currently installed, non-system app can be frozen. An app that is not installed or an app that is an installed system application cannot be frozen.

In embodiments where the user makes the freeze request by dragging an icon to the hiding area, the operating system will determine whether the icon is valid. This determination occurs because an icon may not be an icon for an app but instead may be a shortcut icon, a document icon, or a file folder icon. Therefore, in some embodiments, a technique for determining whether an icon dragged into the hiding area by a user is valid includes determining whether the dragged icon is an icon for an app. If the dragged icon is an icon for an app, the icon is determined to be valid. If the icon is valid, the status of the app corresponding to the icon is set to “application unavailable.” If the icon is not valid, such as if the icon is for a shortcut, then the operating system omits freezing the dragged app and sends back a freeze error message. If the icon is not valid and the icon is for a file folder, the operating system can determine whether each icon in the file folder is an app icon. If each icon in the file folder is an app icon, the operating system can set the statuses of the applications corresponding to those icons in the folder to “application unavailable.” If at least one icon in the file folder is not an app icon, the operating system omits freezing any app in the file folder and sends back a freeze error message.

In some embodiments, different applications invoke each other, and a frozen app cannot be invoked by another application. Therefore, as a result, after the operating system freezes a to-be-processed app, the operating system is to issue a status update broadcast for each process (for example, the process of each app, including system processes and non-system processes) to notify each process that the to-be-processed app has been frozen and to prevent other applications from erroneously invoking the frozen app.

Furthermore, an app having a status set to “application unavailable” cannot be invoked and run. Therefore, after the status of the to-be-processed app is set to “application unavailable,” continuing to display the icon of the to-be-processed app on the desktop would be meaningless. Moreover, continuing to display the icon of the to-be-processed app on the desktop would also mislead the user. Therefore, in some embodiments, after the operating system sets the status of the to-be-processed app to “application unavailable,” the operating system also places the icon for the to-be-processed app in a preset hiding area. As an example, after the operating system sets the status of the to-be-processed app to “application unavailable,” the operating system determines whether the icon for the to-be-processed app is displayed on the desktop. If the icon for the to-be-processed app is displayed on the desktop, the icon for the to-be-processed app is removed from the desktop and placed in the hiding area. If the icon for the to-be-processed app is already placed in the hiding area and is not displayed on the desktop (e.g., the user drags the icon for the to-be-processed app into the hiding area to input a freeze request, in which case the icon for the to-be-processed app has been placed in the hiding area), the to-be-processed app icon does not need to be further moved.

Furthermore, in some embodiments, for easier user identification of a frozen app, in addition to placing the icon for the frozen app in the hiding area, the operation system sets the display of the icon to certain presets. For example, the color saturation of the to-be-processed app icon in the hiding area is set to a preset saturation, the transparency of the to-be-processed app icon is set to a preset transparency, or a combination thereof. For example, the color saturation of the to-be-processed app icon is set to the minimum value (e.g., the minimum value is 0), the transparency of the to-be-processed app icon is set to, for example, 75%, or a combination thereof.

In some embodiments, the operating system includes but is not limited to an Android® operating system. The Android® operating system is provided below as an example to illustrate an example implementation of the app-freezing process 100 of FIG. 1.

The PackageManager component provided in the Android® operating system's software development kit (SDK) can set the status of an app to “application available” (or another status indicating that the application is available) or “application unavailable.” Therefore, when a terminal's operating system is an Android® operating system, the terminal, upon receiving a freeze request for a to-be-processed app, as in above operation 120, can set the status of the to-be-processed app to “application unavailable” by using an application enabled setting function, specifically the PackageManager.setApplicationEnabledSetting( )function supported by the operating system.

After setting the status of the to-be-processed app to “application unavailable,” the operating system issues a status update broadcast to each process. Specifically, the operating system can broadcast using a Package Update message when notifying each process that the to-be-processed app has been frozen. For example, the operation system can send a Package Update message “application updated” to indicate that the application has been updated.

When the operating system sets the color saturation and transparency for the to-be-processed app icon, the operating system can, for example, set the color saturation of the to-be-processed app icon by using the Drawable.setColorFilter( )function provided by the Android® operating system and set the transparency of the to-be-processed app icon by using the Drawable.setAlpha( )function provided by the Android® operating system.

Furthermore, when a desktop process in an Android® operating system is activated (i.e., when the operating system is activated), the desktop process will traverse all of the currently-installed applications. For example, the desktop process (e.g., launcher) obtains application information for all the application by issuing a queryAllAppInfo function call. If the interface and function modules of a certain app cannot be normally invoked, the desktop process is to delete the application data, user data, and icon corresponding to the app (the desktop process is to delete the icon corresponding to the app even if the icon is in the hiding area). As an example, as soon as an app is frozen, the frozen app's interface and function modules cannot be typically invoked. Therefore, when a desktop process is activated, the desktop process will by default delete the application data, user data, and icon corresponding to the frozen app. To prevent the application data, user data, and icon corresponding to a frozen app from being deleted when a desktop process is activated, the following can be performed: when a desktop process is activated, and as soon as the desktop process determines that the interface and function modules of an app cannot be normally invoked, the

PackageManager.getApplicationEnabledSetting( )function is used to determine whether the app has an “application unavailable” status. If the app has an “application unavailable” status, then the application data, user data, and icon corresponding to the app are not deleted. If the app does not have an “application unavailable” status, the application data, user data, and icon corresponding to the app are deleted.

Furthermore, if, while the desktop process is running, a status update broadcast (e.g., a Package Update message) is received, the operating system first determines whether the content of the Package Update message includes a notice that the app has been frozen. If the content of the Package Update message includes a notice that the app has been frozen, the icon for the app is placed in the hiding area. Also, no action is to be performed if the app icon is already in the hiding area. The app icon color saturation, the app icon transparency, or a combination thereof is also set. If the content of the Package Update message is not a notice that the app has been frozen, the app icon can be updated based on the content of the Package Update message, or the app icon can be dealt with as appropriate. The determination of whether the content of the Package Update message includes a notice that the app has been frozen is performed because, in addition to notifying that the app has been frozen, the Package Update message can also notify that the app's icon, name, or content has been updated (e.g., an app upgrade). Therefore, when the desktop process receives the Package Update message, the desktop process will determine whether the content of the Package Update message is to freeze the app or to update the app. If the content of the Package Update message is to freeze the app, then placing the app icon in the hiding area, setting the color saturation, the transparency, or a combination thereof, and performing other such operations are to be performed. If the content of the Package Update message is to update the app, operations such as updating the app icon and name can be performed.

Furthermore, when the status of the to-be-processed app is “available,” the technique whereby the desktop process acquires the icon for the to-be-processed app is as follows: the resolve information object (specifically, the ResolveInfo object) for the to-be-processed app is obtained by using the PackageManager.queryIntentActivities( )function, and then the icon for the to-be-processed app is obtained by using the ResolveInfo.loadIcon( ) function. Furthermore, when the status of the to-be-processed app is “application unavailable,” obtaining the ResolveInfo object by the PackageManager.queryIntentActivities( )function is no longer possible. Therefore, the technique whereby the desktop process acquires the icon for the to-be-processed app is as follows: the application information object (specifically, ApplicationInfo object) for the to-be-processed app is obtained by using the PackageManager.getApplicationInfo( )function, and then the icon for the to-be-processed app is obtained by using the ApplicationInfo.loadIcon( )function.

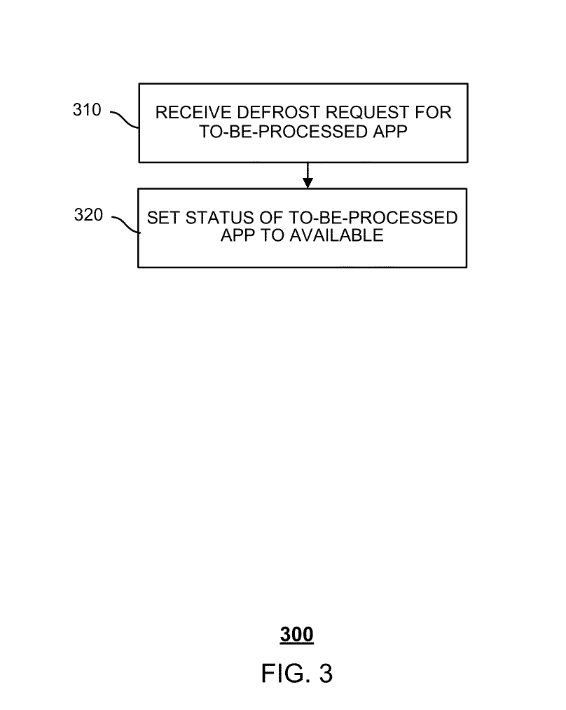

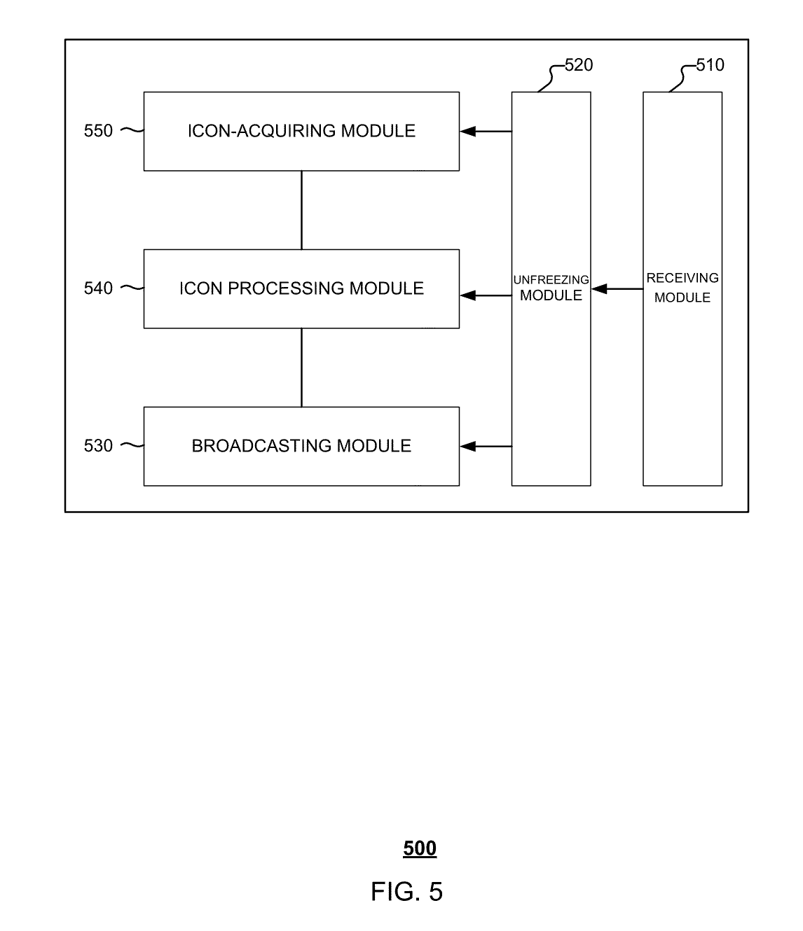

FIG. 3 is a flowchart illustrating an embodiment of a process for unfreezing applications. In some embodiments, the process 300 is implemented by a system or terminal 500 of FIG. 5 and comprises:

In 310, the terminal receives an unfreeze request for the to-be-processed app.

Similar to the app-freezing process 100 of FIG. 1, the user can also input an unfreeze request for the to-be-processed app through a designated system application. The designated system application could be a system application having the highest authority, such as a system settings application.

Furthermore, corresponding to the above app-freezing process 100, in process 300, the user can also select a to-be-processed app icon that is located in the hiding area and drag or move the to-be-processed app icon out from the hiding area (e.g., move the to-be-processed app icon out from the hiding area onto the desktop). By this technique, the user could input an unfreeze request for the to-be-processed app. Thus, when the terminal's operating system detects that the user has moved the to-be-processed app icon out from the hiding area, the terminal's operating system determines that it has received an unfreeze request for the to-be-processed app. The function of the hiding area corresponds to the function of the hiding area in the above app-freezing process 100 of FIG. 1 and will not be further discussed for conciseness.

In 320, the terminal sets the status of the to-be-processed app to “available.” An app with a status set to “available” (or another status indicating that the application is available) is capable of being invoked and run by the operating system.

The app unfreezing process 300 of FIG. 3 is similar to app-freezing process 100 of FIG. 1 in that the operating system still can invoke a designated system application and by invoking the designated system application, the operating system can set the status of the to-be-processed app to “application available.” The invoked system application can be an application having the highest authority, such as a system settings app, and will not be discussed further here for conciseness.

After the user has frozen an app and then later wishes to run the app again, with process 300, downloading and reinstalling the app again is not necessary. Inputting an unfreeze request for the app causes the terminal to set the app's status to “application available,” and allows the app to be run. This process 300 can effectively increase the convenience of user app management.

Similar to the app-freezing process 100 of FIG. 1, after the terminal's operating system sets the status of the to-be-processed app to “application unavailable” (or another status indicating that the application is unavailable), the app unfreezing process 300 can issue a status update broadcast to each process (for example, referring to app processes including system processes and non-system processes) to notify each process that the to-be-processed app has been unfrozen.

In the app-freezing process 100 of FIG. 1, the app icon can be placed in a hiding area when freezing the app. Correspondingly, when unfreezing a to-be-processed app, the operating system can also move the to-be-processed app icon out of the hiding area. For example, the operating system places the to-be-processed app icon back onto the desktop.

Furthermore, when an app is frozen, the color saturation, the transparency, or a combination thereof of the app's icon can be adjusted to a preset saturation, a preset transparency, or a combination thereof. Therefore, when the to-be-processed app is unfrozen, the operating system also can restore the color saturation of the icon for the to-be-processed app from a preset saturation to a default saturation, the transparency of the icon for the to-be-processed app from a preset transparency to a default transparency, or a combination thereof

Operation 320 is similar to the freezing app process 100 of FIG. 1 in that the operating system, which is an Android® operating system in this example, can set the status of the to-be-processed app to “application available” by using the PackageManager.setApplicationEnabledSetting( )function.

Similarly, the operating system can also issue a Package Update message when the operating system is issuing a status update broadcast to notify other processes that the to-be-processed app has been unfrozen.

When the operating system restores the color saturation, the transparency, or a combination thereof for the to-be-processed app icon, the operating system can restore the color saturation by using the Drawable.setColorFilter( )function, the transparency by using the Drawable.setAlpha( )function, or a combination thereof.

If, after the status of the to-be-processed app is set to “application available,” the desktop process has to acquire the icon for the to-be-processed app, then the desktop process can acquire the icon for the to-be-processed app with a conventional technique, for example: the ResolveInfo object for the to-be-processed app is obtained by using the PackageManager.queryIntentActivities( )function, and then the icon for the to-be-processed app is obtained by using the ResolveInfo.loadIcon( )function.

FIG. 4 is a diagram illustrating an embodiment of a system for freezing applications. In some embodiments, the system 400 is configured to implement process 100 of FIG. 1 and comprises: a receiving module 410, a freezing module 420, a storage module 430, a broadcasting module 440, an icon processing module 450, and an icon-acquiring module 460.

In some embodiments, the receiving module 410 is configured to receive a freeze request for a to-be-processed app.

In some embodiments, the freezing module 420 is configured to set a status of the to-be-processed app to “application unavailable.” In some embodiments, an app having a status set to “application unavailable” cannot be invoked and run by the operating system.

In some embodiments, the receiving module 410 is configured to receive a freeze request that is for a to-be-processed app and that was input by a user through a designated system app.

In some embodiments, the receiving module 410 is configured to, when monitoring detects that a user has placed the icon for the to-be-processed app in a preset hiding area, determine that a freeze request for the to-be-processed app has been received.

In some embodiments, the receiving module 410 is configured to receive a freeze request that includes an identifier for the to-be-processed app.

In some embodiments, the freezing module 420 is configured to set the status of the to-be-processed app to “application unavailable” based on the to-be-processed app identifier included in the freeze request upon verifying that the to-be-processed app is valid.

In some embodiments, the freezing module 420 is further configured to search for the to-be-processed app based on the to-be-processed app identifier included in the freeze request; and if, upon confirming the presence of the to-be-processed app, the to-be-processed app is not a system application, determine that the to-be-processed app is valid.

In some embodiments, the freezing module 420 is configured to invoke a designated system application, and set the status of the to-be-processed app to “application unavailable” via the invoked designated system application. In some embodiments, the designated system application relates to a system application having the highest authority.

In some embodiments, the storage module 430 is configured to locally store application data and user data corresponding to the to-be-processed app.

In some embodiments, the broadcasting module 440 is configured to issue a status update broadcast to each process to notify each process that the to-be-processed app has been frozen after the freezing module 420 has set the status of the to-be-processed app to “application unavailable.”

In some embodiments, the icon processing module 450 is configured to place the icon for the to-be-processed app in a preset hiding area after the freezing module 420 has set the status of the to-be-processed app to “application unavailable.”

In some embodiments, the icon processing module 450 is configured to set the color saturation of the icon for the to-be-processed app to a preset saturation, the transparency of the icon for the to-be-processed app to a preset transparency, or a combination thereof

The operating system can include an Android® operating system.

In some embodiments, the freezing module 420 is further configured to set the status of the to-be-processed app to “application unavailable” by using the PackageManager.setApplicationEnabledSetting( )function in the operating system.

In some embodiments, the icon-acquiring module 460 is configured to, when the icon for the to-be-processed app is to be acquired, obtain the ApplicationInfo object for the to-be-processed app by using the PackageManager.getApplicationInfo( )function and obtain the icon for the to-be-processed app by using the ApplicationInfo.loadIcon( )function.

In some embodiments, the above system 400 is implemented by a terminal. In some embodiments, the above system 400 is implemented by an operating system of a terminal.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

FIG. 5 is a diagram illustrating an embodiment of a system for unfreezing applications. In some embodiments, the system 500 is configured to implement process 300 of FIG. 3 and comprises: a receiving module 510, an unfreezing module 520, a broadcasting module 530, an icon processing module 540, and an icon-acquiring module 550.

The status of the to-be-processed app is “application unavailable,” and an app having a status set to “application unavailable” cannot be invoked and run by the system.

In some embodiments, the receiving module 510 is configured to receive an unfreeze request for the to-be-processed app.

In some embodiments, the unfreezing module 520 is configured to set the status of the to-be-processed app to “application available.” In some embodiments, an app with status set to “application available” can be invoked and run by the operating system.

In some embodiments, the receiving module 510 is configured to receive an unfreeze request that is for a to-be-processed app and that was input by a user via a designated system application.

When the status of the to-be-processed app is “application unavailable,” the icon for the to-be-processed app is located in a preset hiding area.

In some embodiments, the receiving module 510 is configured to, when monitoring detects that a user has moved the icon for the to-be-processed app out of the hiding area, determine that an unfreeze request for the to-be-processed app has been received.

In some embodiments, the unfreezing module 520 is configured to invoke a designated system application, and set the status of the to-be-processed app to “application available” through the invoked designated system application. In some embodiments, the designated system application includes a system application having the highest authority.

In some embodiments, the broadcasting module 530 is configured to issue a status update broadcast to each process to notify each process that the to-be-processed app has been unfrozen after the unfreezing module 520 has set the status of the to-be-processed app to “application available.”

When the status of the to-be-processed app is “application unavailable,” the icon for the to-be-processed app is located in a preset hiding area.

In some embodiments, the icon processing module 540 is configured to move the icon for the to-be-processed app out of the preset hiding area.

When the status of the to-be-processed app is “application unavailable,” the color saturation of the icon for the to-be-processed app corresponds to a preset saturation, the transparency of the icon for the to-be-processed app corresponds to a preset transparency, or a combination thereof.

In some embodiments, the icon processing module 540 is configured to restore the color saturation of the icon for the to-be-processed app from a preset saturation to a default saturation, the transparency of the icon for the to-be-processed app from a preset transparency to a default transparency, or a combination thereof.

The operating system can include an Android® operating system.

In some embodiments, the unfreezing module 520 is configured to set the status of the to-be-processed app to “application available” by using the PackageManager.setApplicationEnabledSetting( )function in the operating system.

In some embodiments, the icon-acquiring module 550 is configured to, when the icon for the to-be-processed app is to be acquired, obtain the ResolveInfo object for the to-be-processed app by using the PackageManager.queryIntentActivities( )function and obtain the icon for the to-be-processed app by using the ResolveInfo.loadIcon( )function.

In some embodiments, the above system 500 of FIG. 5 is implemented by a terminal. In some embodiments, the above system 500 of FIG. 5 is implemented by the operating system of a terminal.

When a terminal receives a freeze request for a to-be-processed app, the terminal sets the status of the to-be-processed app to “application unavailable,” and an app with status set to “application unavailable” cannot be invoked and run by the system. When the terminal receives an unfreeze request for a to-be-processed app, the terminal sets the status of the to-be-processed app to “application available,” and thus the to-be-processed app can be normally invoked and run by the system. With the above process 100 of FIG. 1, if a user does not need an app, and if the app does not provide a “disable” option, the user can set the app's status to “application unavailable” through the terminal without having to uninstall the app. If later the user wishes to use the app again, the terminal can set the app's status to “application available.” This effectively makes app management more convenient for users.

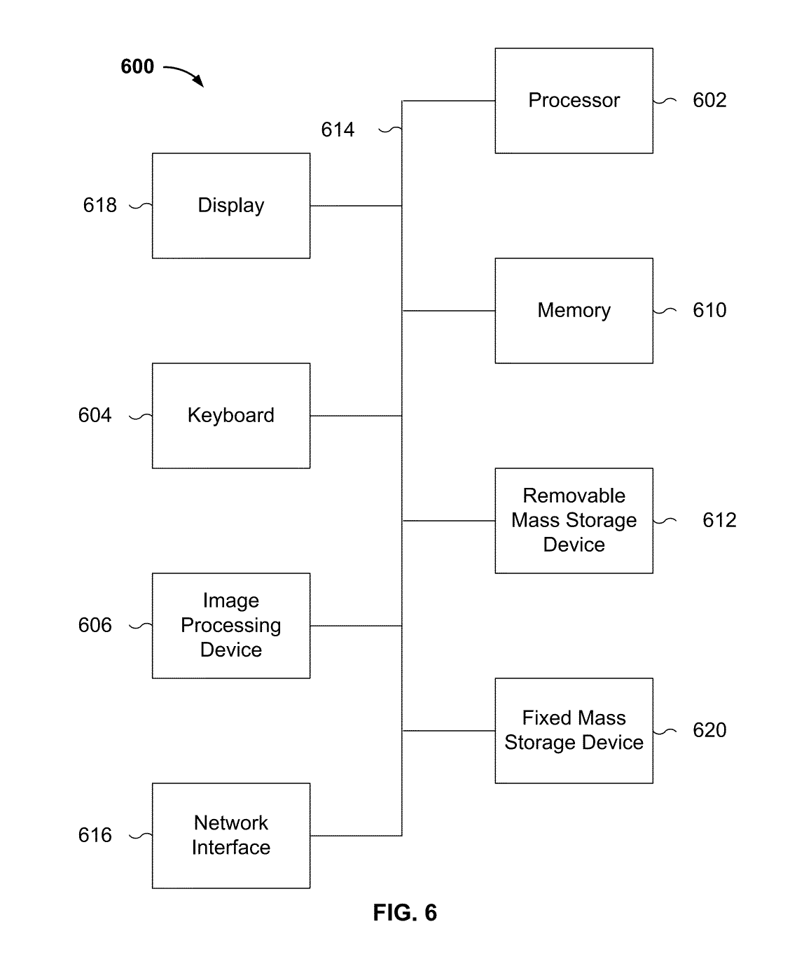

FIG. 6 is a functional diagram illustrating an embodiment of a programmed computer system for freezing or unfreezing applications. As will be apparent, other computer system architectures and configurations can be used to perform the described freezing or unfreezing applications technique. Computer system 600, which includes various subsystems as described below, includes at least one microprocessor subsystem (also referred to as a processor or a central processing unit (CPU) 602). For example, processor 602 can be implemented by a single-chip processor or by multiple processors. In some embodiments, processor 602 is a general purpose digital processor that controls the operation of the computer system 600. In some embodiments, processor 602 also includes one or more coprocessors or special purpose processors (e.g., a graphics processor, a network processor, etc.). Using instructions retrieved from memory 610, processor 602 controls the reception and manipulation of input data received on an input device (e.g., image processing device 606, I/O device interface or keyboard 604), and the output and display of data on output devices (e.g., display 618).

Processor 602 is coupled bi-directionally with memory 610, which can include, for example, one or more random access memories (RAM) and/or one or more read-only memories (ROM). As is well known in the art, memory 610 can be used as a general storage area, a temporary (e.g., scratch pad) memory, and/or a cache memory. Memory 610 can also be used to store input data and processed data, as well as to store programming instructions and data, in the form of data objects and text objects, in addition to other data and instructions for processes operating on processor 602. Also as is well known in the art, memory 610 typically includes basic operating instructions, program code, data, and objects used by the processor 602 to perform its functions (e.g., programmed instructions). For example, memory 610 can include any suitable computer readable storage media described below, depending on whether, for example, data access needs to be bi-directional or uni-directional. For example, processor 602 can also directly and very rapidly retrieve and store frequently needed data in a cache memory included in memory 610.

A removable mass storage device 612 provides additional data storage capacity for the computer system 600, and is optionally coupled either bi-directionally (read/write) or uni-directionally (read only) to processor 602. A fixed mass storage 620 can also, for example, provide additional data storage capacity. For example, storage devices 612 and/or 620 can include computer readable media such as magnetic tape, flash memory, PC-CARDS, portable mass storage devices such as hard drives (e.g., magnetic, optical, or solid state drives), holographic storage devices, and other storage devices. Mass storages 612 and/or 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can be used to provide access to other subsystems and devices as well. As shown, these can include a display 618, a network interface 616, an input/output (I/O) device interface or keyboard 604, an image processing device 606, as well as other subsystems and devices. For example, image processing device 606 can include a camera, a scanner, etc.; I/O device interface or keyboard 604 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 600. Multiple I/O device interfaces can be used in conjunction with computer system 600. The I/O device interface can include general and customized interfaces that allow the processor 602 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 616 allows processor 602 to be coupled to another computer, computer network, or telecommunications network using a network connection as shown. For example, through the network interface 616, the processor 602 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

In addition, various embodiments disclosed herein further relate to computer storage products with a computer readable medium that includes program code for performing various computer-implemented operations. The computer readable medium includes any data storage device that can store data which can thereafter be read by a computer system. Examples of computer readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system shown in FIG. 6 is but an example of a computer system suitable for use with the various embodiments disclosed herein. Other computer systems suitable for such use can include additional or fewer subsystems. In some computer systems, subsystems can share components (e.g., for touchscreen-based devices such as smart phones, tablets, etc., I/O device interface or keyboard 604 and display 618 share the touch sensitive screen component, which both detects user inputs and displays outputs to the user). In addition, bus 614 is illustrative of any interconnection scheme serving to link the subsystems. Other computer architectures having different configurations of subsystems can also be utilized.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a request for an application installed on a computer system; and
in response to the request, setting a status of the application to a status value indicating that the application is to become unavailable while maintaining the application and its associated data on the computer system, wherein the application cannot be invoked or run by an operating system after the status is set to the status value.

2. The method as described in claim 1, wherein the request was input by a user through a designated system application.

3. The method as described in claim 1, wherein the receiving of the request for the application comprises:
detecting that a user has placed an icon for the application in a preset hiding area; and
determining that the request has been received.

4. The method as described in claim 1, wherein:
the request includes an identifier for the application; and
the setting of the status of the application to the status value comprises:
setting the status of the application to the status value upon verifying that the application is valid based on the application identifier included in the request.

5. The method as described in claim 1, wherein:
the request includes an identifier for the application;
the setting of the status of the application to the status value comprises:
setting the status of the application to the status value upon verifying that the application is valid based on the application identifier included in the request; and
the verifying that the application is valid based on the application identifier included in the request comprises:
searching for the application based on the application identifier included in the request; and
determining whether the application is a system application.

6. The method as described in claim 1, wherein the setting of the status of the application to the status value comprises:
invoking a designated system application, wherein the designated system application comprises a system application having the highest authority; and
setting the status of the application to the status value via the invoked designated system application.

7. The method as described in claim 1, further comprising:
locally storing application data and user data corresponding to the application.

8. The method as described in claim 1, further comprising:
issuing one or more status update broadcasts to a plurality of processes on the computer system to notify the plurality of processes that the application has been frozen.

9. The method as described in claim 1, further comprising:
placing an icon for the application in a preset hiding area.

10. The method as described in claim 1, further comprising:
placing an icon for the application in a preset hiding area; and
setting a color saturation of the icon for the application to a preset saturation, a transparency of the icon for the application to a preset transparency, or both.

11. The method as described in claim 1, wherein the operating system includes an Android® operating system.

12. The method as described in claim 1, wherein:
the operating system includes an Android® operating system; and
the status of the application is set to the status value by using an application enabled setting function.

13. The method as described in claim 1, wherein the status value is a first status value, and the method further comprising:
after the setting of the status of the application to a second status value indicating that the application is to become available, obtaining an icon for the application, including:
obtaining an application information object for the application; and
obtaining the icon for the application based at least in part on the application information object, wherein the operating system includes an Android® operating system.

14. A method, comprising:
receiving a request for an application installed on a computer system, wherein a status of the application is a first status value indicating that the application is unavailable and the application cannot be invoked or run by an operating system while the status of the application is the first status value; and
in response to the request, setting the status of the application from the first status value to a second status value indicating that the application is to become available while maintaining the application and its associated data on the computer system, wherein the application can be invoked or run by the operating system while the status of the application is set to the second status value.

15. The method as described in claim 14, wherein the request was input by a user through a designated system application.

16. The method as described in claim 14, wherein:
when the status of the application is the first status value, an icon for the application is located in a preset hiding area; and
the receiving of the request for the application comprises:
detecting that a user has moved the icon for the application out of the hiding area; and
determining that the request for the application has been received.

17. The method as described in claim 14, wherein the setting of the status of the application to the second status value comprises:
invoking a designated system application, wherein the designated system application comprises a system application having the highest authority; and
setting the status of the application to the second status value via the invoked designated system application.

18. The method as described in claim 14, further comprising:
after the setting of the status of the application to the second status value, issuing one or more status update broadcasts to a plurality of processes to notify the plurality of processes that the application has been unfrozen.

19. The method as described in claim 14, further comprising:
after setting the status from the first status value to the second status value, moving an icon for the application that is located in a preset hiding area out of the preset hiding area.

20. A system, comprising:
a processor; and
a memory coupled with the processor, wherein the memory is configured to provide the processor with instructions which when executed cause the processor to:
receive a request for an application installed on a computer system; and
in response to the request, set a status of the application to a status value indicating that the application is to become unavailable while maintaining the application and its associated data on the computer system, wherein the application cannot be invoked or run by an operating system after the status is set to the status value.

21. A system, comprising:
a processor; and
a memory coupled with the processor, wherein the memory is configured to provide the processor with instructions which when executed cause the processor to:
receive a request for an application installed on a computer system, wherein a status of the application is a first status value indicating that the application is unavailable and the application cannot be invoked or run by an operating system while the status of the application is the first status value; and
in response to the request, set the status of the application from the first status value to a second status value indicating that the application is to become available while maintaining the application and its associated data on the computer system, wherein the application can be invoked or run by the operating system while the status of the application is set to the second status value.

22. A computer program product being embodied in a tangible non-transitory computer readable storage medium and comprising computer instructions for:
receiving a request for an application installed on a computer system; and
in response to the request, setting a status of the application to a status value indicating that the application is to become unavailable while maintaining the application and its associated data on the computer system, wherein the application cannot be invoked or run by an operating system after the status is set to the status value.

23. A computer program product being embodied in a tangible non-transitory computer readable storage medium and comprising computer instructions for:
receiving a request for an application installed on a computer system, wherein a status of the application is a first status value indicating that the application is unavailable and the application cannot be invoked or run by an operating system while the status of the application is the first status value; and
in response to the request, setting the status of the application from the first status value to a second status value indicating that the application is to become available while maintaining the application and its associated data on the computer system, wherein the application can be invoked or run by the operating system while the status of the application is set to the second status value.
